(19) United States
(12) Patent Application Publication
(10) Pub. No.: US 2019/0223429 A1
(43) Pub. Date: Jul. 25, 2019

(54) Animal device

(71) Applicant: Derick Williams, Richland, MS (US)

(72) Inventor: Derick Williams, Richland, MS (US)

(21) Appl. No.: 15/880,076

(22) Filed: Jan. 25, 2018

(51) Int. Cl. A01M 23/16; A01K 1/02; A01K 1/03

(52) U.S. Cl. CPC A01M 23/16; A01K 1/0272; A01K 1/031; A01K 1/0245

(57) ABSTRACT

A animal device to capture live animals may include a top wall; a bottom wall opposed to the top wall; a pair of opposing side walls to connect the top wall and the bottom wall; a removable back wall to connect to the top wall, the bottom wall and the side walls; an inclined wall connected to the top wall having a first magnetic portion; and a pivoting platform being pivotably mounted on the opposing side walls having a second magnetic portion.

### FIELD OF THE INVENTION

The present invention relates to an animal device and more particularly to a live capture small animal device.

### BACKGROUND

There are many types of small animals that generally are not welcome in today's households and business communities. There are many ways of exterminating these small animals, but there is a need for a way to trap these small animals without harming them. There are various catch and release devices that can trap the small animals without harm. These devices are becoming more and more popular as the humane movement grows. Many of these devices employ a spring mechanism to close the entrance to the trap. However none of these devices employs a force outside of gravity in order to close the entrance to the trap.

### SUMMARY

A animal device to capture live animals may include a top wall; a bottom wall opposed to the top wall; a pair of opposing side walls to connect the top wall and the bottom wall; a removable back wall to connect to the top wall, the bottom wall and the side walls; an inclined wall connected to the top wall having a first magnetic portion; and a pivoting platform being pivotably mounted on the opposing side walls having a second magnetic portion.

The first magnetic portion and the second magnetic portion may be engaged to seal a front aperture to the animal device.

The inclined wall may be L-shaped.

The back wall may include a back platform.

The pivoting platform may pivot on a pivoting axle connected to the sidewalls.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an exploded view of the animal device of the present invention;

FIG. 2 illustrates a side view of the animal device with the entranceway open.

FIG. 3 illustrates a perspective view of the animal device with the entranceway closed.

### DETAILED DESCRIPTION

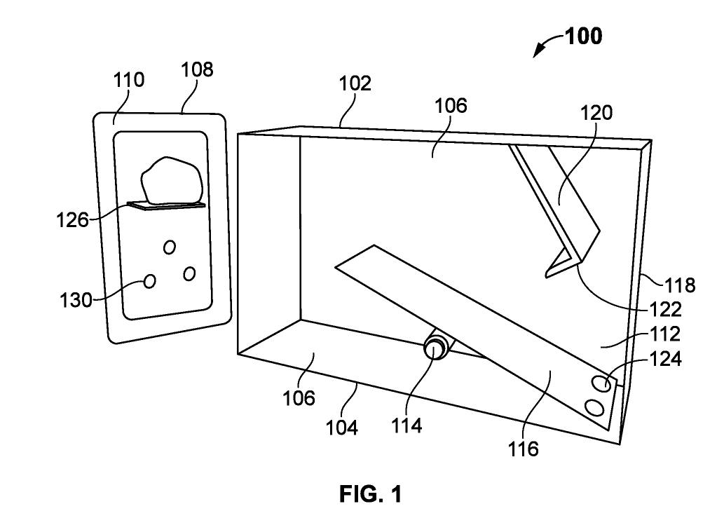

FIG. 1 illustrates a perspective view of the animal device 100 of the present invention and illustrates a generally rectangular cross-section shaped device with a top wall 102, an opposed bottom wall 104 and a pair of opposing side walls 106 to connect the top wall 102 with the bottom wall 104. The animal device 100 additionally includes a back wall 108 which may be removed and replaced and may include an inward extending lip 110 which may extend around the periphery of the back wall 108 to achieve a friction fit with the opposing side walls 106, the top wall 102 and the bottom wall 104. An front edge of the opposing side walls 106, the top wall 102 and the bottom wall 104 define a periphery of an front aperture 118 for an entranceway into an internal cavity 112 of the animal device 100 to allow the animal (such as a mouse or rat or other small animal to enter the animal device 100.

A pivoting axle 114 may extend substantially horizontally between the opposing side walls 106 and may be connected to a pivoting platform 116 which may pivot between an open position where the platform 116 allows the animal to enter the internal cavity 112 and a closed position where the platform 116 rotates to prevent the animal from escaping from the internal cavity 112 by blocking the front cavity 118. An L-shaped inclined wall 120 may extend downward from the top wall 102 and may include a first magnetic portion 122 to engage a second magnetic portion 124 formed within the pivoting platform 116. When the first magnetic portion 122 approaches the second magnetic portion 124 as a result of the pivoting of the pivoting platform 116, the first magnetic portion 122 will be attracted to and hold the second magnetic portion 124 as a result of the magnetic attraction between the first magnetic portion 122 and the second magnetic portion 124.

The opposing end of the pivoting platform 116 may be held against the bottom wall 104 of the animal device 100. As a result, the pivoting platform 116 and the L-shaped inclined wall 120 form a barrier to prevent the animal from escaping the animal device 100 and which may extend from the bottom wall 104 to the top wall 102.

The back wall 108 may include a bait platform 126 which may extend from the back wall 108 allowing bait for the animal to be placed so as the animal may move to the bait and away from the front aperture 118. Furthermore, the back wall 108 may include apertures 130 which may extend through the back wall 108 in order to allow the aroma of the bait to flow outside of the animal device 100.

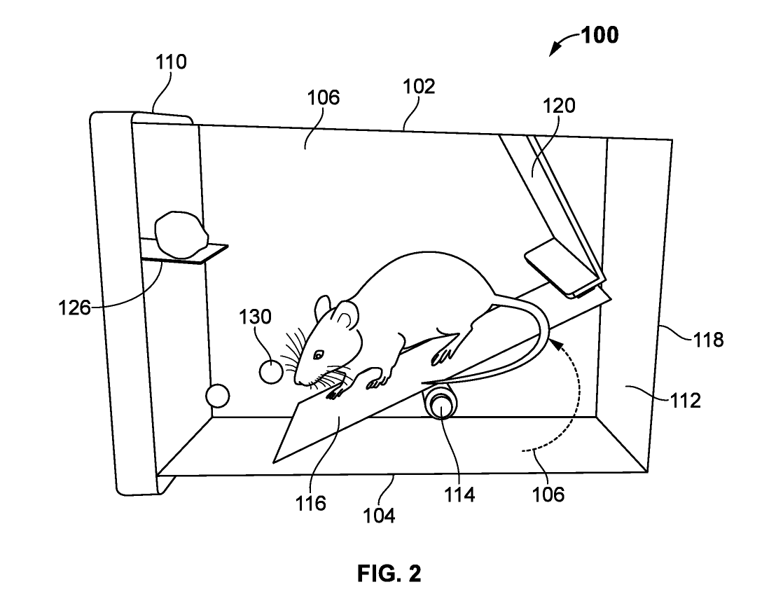

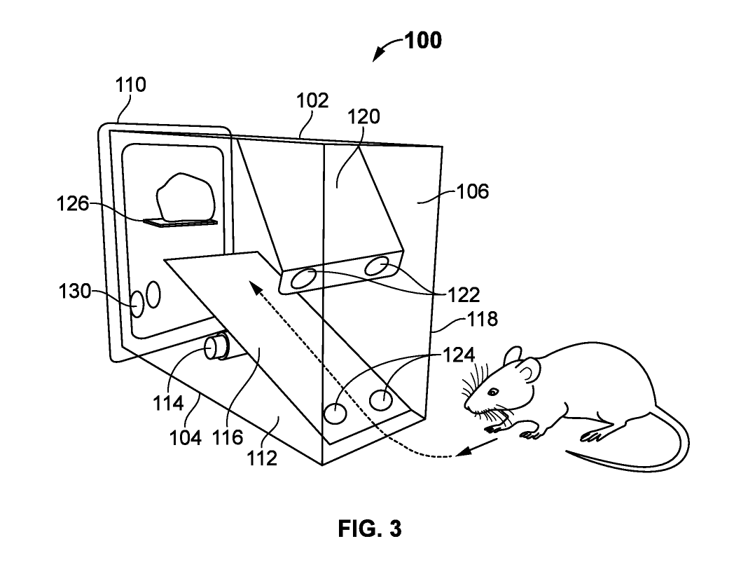

FIG. 2 illustrates a perspective view of the animal device 100 of the present invention and illustrates a generally rectangular cross-section shaped device with a top wall 102, an opposed bottom wall 104 and a pair of opposing side walls 106 to connect the top wall 102 with the bottom wall 104. The animal device 100 additionally includes a back wall 108 which may be removed and replaced and may include an inward extending lip 110 which may extend around the periphery of the back wall 108 to achieve a friction fit with the opposing side walls 106, the top wall 102 and the bottom wall 104. An front edge of the opposing side walls 106, the top wall 102 and the bottom wall 104 define a periphery of an front aperture 118 for an entranceway into an internal cavity 112 of the animal device 100 to allow the animal (such as a mouse or rat or other small animal to enter the animal device 100. FIG. 2 illustrates that the front aperture 118 is open to allow the animal to enter the internal cavity 112 by moving on the pivoting platform 116. The pivoting platform rotates to deposit the animal within the internal cavity 112 and blocking the front aperture 118 with the pivoting platform 116 and the L-shaped inclined wall 120 which may be held in place by the attraction of the first magnetic portion 122 and the second magnetic portion 124 as shown in FIG. 3.

A pivoting axle 114 may extend substantially horizontally between the opposing side walls 106 and may be connected to a pivoting platform 116 which may pivot between an open position where the platform 116 allows the animal to enter the internal cavity 112 and a closed position where the platform 116 rotates to prevent the animal from escaping from the internal cavity 112 by blocking the front cavity 118. An L-shaped inclined wall 120 may extend downward from the top wall 102 and may include a first magnetic portion 122 to engage a second magnetic portion 124 formed within the pivoting platform 116. When the first magnetic portion 122 approaches the second magnetic portion 124 as a result of the pivoting of the pivoting platform 116, the first magnetic portion 122 will be attracted to and hold the second magnetic portion 124 as a result of the magnetic attraction between the first magnetic portion 122 and the second magnetic portion 124.

The opposing end of the pivoting platform 116 may be held against the bottom wall 104 of the animal device 100. As a result, the pivoting platform 116 and the L-shaped inclined wall 120 form a barrier to prevent the animal from escaping the animal device 100 and which may extend from the bottom wall 104 to the top wall 102.

The back wall 108 may include a bait platform 126 which may extend from the back wall 108 allowing bait for the animal to be placed so as the animal may move to the bait and away from the front aperture 118. Furthermore, the back wall 108 may include apertures 130 which may extend through the back wall 108 in order to allow the aroma of the bait to flow outside of the animal device 100.

FIG. 3 illustrates a perspective view of the animal device 100 of the present invention and illustrates a generally rectangular cross-section shaped device with a top wall 102, an opposed bottom wall 104 and a pair of opposing side walls 106 to connect the top wall 102 with the bottom wall 104. The animal device 100 additionally includes a back wall 108 which may be removed and replaced and may include an inward extending lip 110 which may extend around the periphery of the back wall 108 to achieve a friction fit with the opposing side walls 106, the top wall 102 and the bottom wall 104. An front edge of the opposing side walls 106, the top wall 102 and the bottom wall 104 define a periphery of an front aperture 118 for an entranceway into an internal cavity 112 of the animal device 100 to allow the animal (such as a mouse or rat or other small animal to enter the animal device 100.

A pivoting axle 114 may extend substantially horizontally between the opposing side walls 106 and may be connected to a pivoting platform 116 which may pivot between an open position where the platform 116 allows the animal to enter the internal cavity 112 and a closed position where the platform 116 rotates to prevent the animal from escaping from the internal cavity 112 by blocking the front cavity 118. An L-shaped inclined wall 120 may extend downward from the top wall 102 and may include a first magnetic portion 122 to engage a second magnetic portion 124 formed within the pivoting platform 116. When the first magnetic portion 122 approaches the second magnetic portion 124 as a result of the pivoting of the pivoting platform 116, the first magnetic portion 122 will be attracted to and hold the second magnetic portion 124 as a result of the magnetic attraction between the first magnetic portion 122 and the second magnetic portion 124.

The opposing end of the pivoting platform 116 may be held against the bottom wall 104 of the animal device 100. As a result, the pivoting platform 116 and the L-shaped inclined wall 120 form a barrier to prevent the animal from escaping the animal device 100 and which may extend from the bottom wall 104 to the top wall 102.

The back wall 108 may include a bait platform 126 which may extend from the back wall 108 allowing bait for the animal to be placed so as the animal may move to the bait and away from the front aperture 118. Furthermore, the back wall 108 may include apertures 130 which may extend through the back wall 108 in order to allow the aroma of the bait to flow outside of the animal device 100.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A animal device to capture live animals, comprising:
a top wall;
a bottom wall opposed to the top wall;
a pair of opposing side walls to connect the top wall and the bottom wall;
a removable back wall to connect to the top wall, the bottom wall and the side walls;
an inclined wall connected to the top wall having a first magnetic portion;
a pivoting platform being pivotably mounted on the opposing side walls having a second magnetic portion;
wherein the first magnetic portion and the second magnetic portion engaged to seal a front aperture to the animal device.

2) A animal device to capture live animals as in claim 1, wherein the inclined wall is L-shaped.

3) A animal device to capture live animals as in claim 1, wherein the back wall includes a back platform.

4) A animal device to capture live animals as in claim 1, where in the pivoting platform pivots on a pivoting axle connected to the sidewalls.
